(19) United States
(12) Patent Application Publication
(10) Pub. No.: US 2023/0007544 A1
(43) Pub. Date: Jan. 5, 2023

(54) METHODS AND DEVICES FOR UPDATING DATA TRANSMISSION DURING INTER-DONOR MIGRATION

(71) Applicant: ZTE Corporation, Shenzhen (CN)

(72) Inventors: Hao ZHU, Shenzhen (CN); Ying HUANG, Shenzhen (CN); Lin CHEN, Shenzhen (CN); Liping WANG, Shenzhen (CN); Kun CAO, Shenzhen (CN)

(21) Appl. No.: 17/943,317

(22) Filed: Sep. 13, 2022

Related U.S. Application Data
(63) Continuation of application No. PCT/CN2020/079252, filed on Mar. 13, 2020.

(51) Int. Cl. H04W 36/00; H04W 36/10

(52) U.S. Cl. CPC H04W 36/0055; H04W 36/10

(57) ABSTRACT

The present disclosure describes methods, systems, and devices for informing at least one downstream device of a migrating integrated access backhaul node (IAB-node) about an inter-donor migration status of migrating IAB node undergoing a migration from a source IAB-donor to a target IAB-donor. The method includes receiving, by a receiving device, a radio resource control (RRC) message sent from an IAB-donor. The RRC message includes an information element which indicates an inter-donor migration status of a migrating IAB-node. The method further includes in response to the information element indicating a successful inter-donor migration, sending, by the receiving device, a packet data convergence protocol (PDCP) status reports to a target IAB-donor. The PDCP status report corresponds to a radio link control acknowledged mode (RLC-AM) bearer configured to be allowed to send the PDCP status report in an uplink, and is configured to update data transmission for the receiving device.

### TECHNICAL FIELD

The present disclosure is directed generally to wireless communications. Particularly, the present disclosure relates to methods and devices for updating data transmission during inter-donor migration.

### BACKGROUND

Wireless communication technologies are moving the world toward an increasingly connected and networked society. Compared with long term evolution (LTE), the fifth generation (5G) new radio (NR) technology have a much wider spectrum, for example, including millimeter wave (mmWave) frequency bands. With the development of massive multiple input multiple output (MIMO) and/or multiple-beam systems, the 5G NR may provide a much faster speed and much shorter latency.

The 5G NR may include an integrated access backhaul (IAB) implementation. The IAB implementation may include one or more IAB-donors and multiple connecting IAB-nodes. Currently, there are problems and/or issues associated with updating data transmission of downstream devices, particularly when one IAB node migrates from one IAB-donor to another IAB-donor.

The present disclosure may address at least some of problems/issues associated with the existing system to improve the performance of the wireless communication.

### SUMMARY

This document relates to methods, systems, and devices for wireless communication, and more specifically, for updating data transmission for a downstream device of a migrating integrated access backhaul node (IAB-node) during inter-donor migration.

In one embodiment, the present disclosure describes a method for wireless communication. The method includes receiving, by a receiving device, a radio resource control (RRC) message sent from a transmitting device, the RRC message comprising first information which indicates inter IAB-donor migration related information, the transmitting device comprising one of a subset, the subset comprising at least one of a target nodeB (gNB), a target gNB central unit (gNB-CU), a source gNB, and a source gNB-CU.

In another embodiment, the present disclosure describes a method for wireless communication. The method includes receiving, by a receiving device, a medium access control (MAC) control element (CE) sent from a transmitting device, the MAC CE comprising a first information which indicates inter IAB-donor migration related information.

In another embodiment, the present disclosure describes a method for wireless communication. The method includes sending, by a first IAB-node as a transmitting device, a backhaul adaptation protocol (BAP) control protocol data unit (PDU) to a second IAB-node, the BAP control PDU comprising first information that indicates inter IAB-donor migration related information.

In another embodiment, the present disclosure describes a method for wireless communication. The method includes sending, by a first IAB-node as a transmitting device, a backhaul adaptation protocol (BAP) control protocol data unit (PDU) to a second IAB-node, the BAP control PDU comprising first information that indicates inter IAB-donor migration related information.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include an integrated access backhaul (IAB) system.

FIG. 2 shows an example of an IAB-donor or IAB-node.

FIG. 3 shows an example of a user equipment.

FIG. 4 shows a schematic diagram of a migrating IAB-node in an inter-donor migration.

FIG. 5 shows a flow diagram of a method for wireless communication.

FIG. 6 shows an exemplary logic flow of the method for wireless communication in FIG. 5.

FIG. 7A shows a flow diagram of another method for wireless communication.

FIG. 7B shows an example of a medium access control (MAC) control element (CE).

FIG. 7C shows an example of a dedicated logic channel identifier (LCID) value.

FIG. 8 shows an exemplary logic flow of the method for wireless communication in FIG. 7A.

FIG. 9A shows a flow diagram of another method for wireless communication.

FIG. 9B shows several examples of configuration formats for a backhaul adaptation protocol (BAP) control protocol data unit (PDU).

FIG. 9C shows one example of a backhaul adaptation protocol (BAP) control protocol data unit (PDU).

FIG. 9D shows another example of a backhaul adaptation protocol (BAP) control protocol data unit (PDU).

FIG. 9E shows one example of a dedicated radio link failure (RLF) indication type value.

FIG. 10 shows an exemplary logic flow of the method for wireless communication in FIG. 9A.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for updating data transmission for a downstream device of a migrating integrated access backhaul node (IAB-node) during inter-donor migration.

Next generation (NG), or 5th generation (5G), wireless communication may provide a range of capabilities from downloading with fast speeds to support real-time low-latency communication. Compared with long-term evolution (LTE), the 5G new radio (NR) technology have a much wider spectrum, for example, including millimeter wave (mmWave) frequency bands. With the development of massive multiple input multiple output (MIMO) and/or multiple-beam systems, the 5G NR may provide a much faster speed and much shorter latency. The 5G NR may include a development of an integrated access backhaul (IAB) implementation. The IAB implementation may include one or more IAB-donors and multiple connecting IAB-nodes. The IAB implementation may communicate between one or more IAB-donors and one or more IAB-nodes via wireless backhaul and relay links. The IAB implementation may provide a flexible NR cell configuration and increase cell density without increasing the density of IAB-donors.

An IAB system may include one or more IAB-donors and one or more IAB-nodes, which collectively provide wireless connection service to one or more user equipment (UEs) (e.g., smartphones). The IAB-donors and IAB-nodes may be wireless network base stations including a NG radio access network (NG-RAN) base station, which may include a nodeB (NB, e.g., a gNB) in a mobile telecommunications context. The IAB-donor may provide access backhaul to one or more connecting child IAB-nodes, and may connect to a core network via a wired communication. In one implementation, the core network may include a 5G core network (5GC). In another implementation, the wired communication may include a fiber transport communication. The IAB-node may include wireless access link and wireless backhaul link. The wireless access link may be used for communication between a UE and the IAB-node. The wireless backhaul link may be used for communication between the IAB-node and the IAB-donor, and/or communications between one IAB-node with another IAB-node. Thus, the IAB-node does not need a wired communication network for data backhaul. In some implementations, the IAB-node does not include a wired communication network for data backhaul, so that IAB-node are more flexible and easier to implement, mitigating the burden of implementing wired communication network. The access link and backhaul link may use transmission bands with same frequency (known as in-band relay), or use transmission bands with different frequency (known as out-band relay).

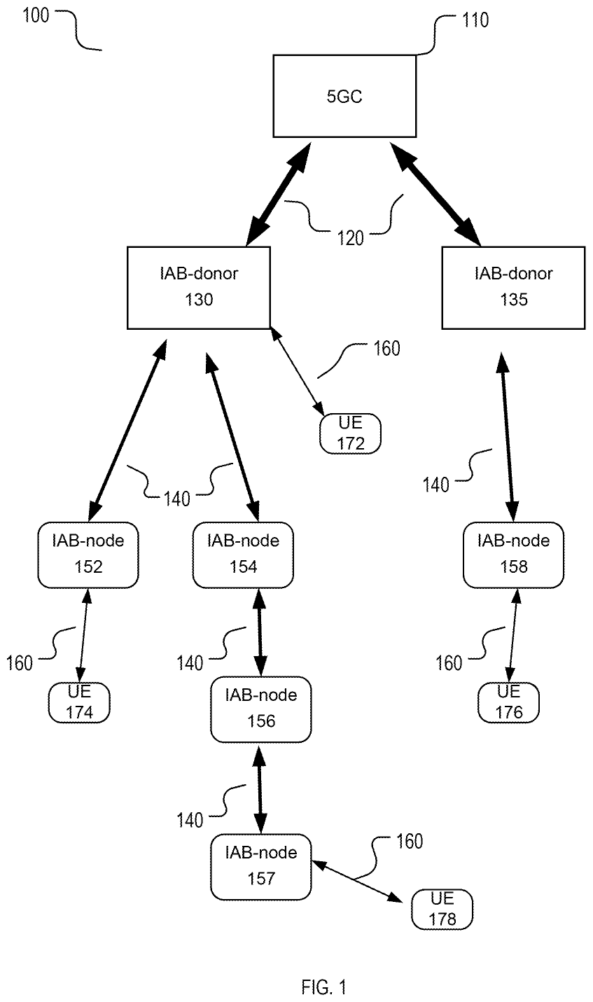

Referring to FIG. 1, the IAB-donor 130 may provide access backhaul 140 to one or more connecting child IAB-nodes (152 and 154). The IAB-donor 130 may connect to a core network 110 via a wired communication 120. In one implementation, the core network 110 may include a 5G core network (5GC). In another implementation, the wired communication 120 may include a fiber transport communication.

An IAB-donor may provide a wireless connection to one or more user equipment (UE). The UE may be a mobile device, for example, a smart phone or a mobile communication module disposed in a vehicle. For example, the IAB-donor 130 may provide a wireless connection 160 to a UE 172.

Similarly and without limitation, a child IAB-node may provide a wireless connection to one or more UEs. For example, the IAB-node 152 may provide a wireless connection 160 to a UE 174.

Similarly and without limitation, a child IAB-node may provide access backhaul to one or more downstream IAB-nodes. For example, the IAB-node 154 may provide access backhaul 140 to a downstream IAB-node 156 and a downstream IAB-node 157. In the view of the IAB-node 154, the IAB-node 156 may be called as a child IAB-node of the IAB-node 154; and the IAB-node 157 may be called as a grandchild IAB-node of the IAB-node 154.

Similarly and without limitation, the grandchild IAB-node 157 may also provide access backhaul to one or more connecting great-grandchild IAB-nodes and/or provide wireless connection to one or more UEs (for example, UE 178).

In one implementation, the IAB system 100 may include another IAB-donor 135. The IAB-donor 135 may also connect to the core network (e.g., 5GC) 110 via a wired communication 120. The IAB-donor 135 may provide access backhaul 140 to one or more connecting child IAB-nodes 158; and the IAB-node 158 may provide a wireless connection 160 to one or more UE 176.

The IAB-node 156, which currently connects to the IAB-donor 130 via the IAB-node 154, may migrate to the IAB-donor 135. This may be called as an inter-donor migration and the IAB-node 156 may be called as a migrating IAB-node. Currently, there are problems and/or issues associated with updating data transmission for a downstream device (IAB-node or UE) during and/or after the inter-donor migration.

In one embodiment with NR system, after inter-gNB migration, the target gNB may retransmit a portion of the data packets so as to ensure a continuation of the communication service to a UE. To minimize the portion of the data packets, the UE may send a packet data convergence protocol (PDCP) status report to the target gNB. The PDCP status report may inform the target gNB the conditions (e.g., failure or success conditions) of the data packets received by the UE, and thus, the target gNB may decide which data packet is selected for retransmission or transmission. In the current system, UE's sending PDCP status report may be triggered by PDCP data recovery and/or PDCP re-establishment. In both implementations with the PDCP re-establishment and the PDCP data recovery, UE may need to retransmit PDCP protocol data units (PDUs) or PDCP service data units (SDUs) that have not been confirmed by a lower layer (for example, radio link control (RLC) layer).

In one implementation with PDCP re-establishment, UE may send PDCP status report during inter-gNB migration by the following procedures. The target gNB may send a radio resource control (RRC) message via the source gNB. The RRC message may be configured inside a RRC container of the source gNB and the UE; the RRC message may also include an information element of re-establish PDCP. The information element of re-establish PDCP may trigger PDCP re-establishment procedure, and trigger UE to send PDCP status reporter. The UE may send the PDCP status report to target gNB after the connection between the UE and the target gNB is successfully established.

In the IAB system, to avoid unnecessary retransmission of data packets and ensure service continuity, the UE may report the PDCP status report. However, some problems/issues occur. One of the problems/issues may include that, after the migrating IAB-node establishes connection between the IAB-node and target gNB-CU, a UE connecting with the migrating IAB-node may need be triggered to send PDCP status report to the target IAB-donor. The triggering events may include one of the PDCP data recovery procedure and the PDCP re-establishment procedure. This may lead to retransmission of data packets which could arrive at IAB-donor CU but was in the source route during the period of the migrating IAB-node's migration, then wasting network resources and resulting in low performance.

The present disclosure describes embodiments of methods and devices of updating configuration information for at least one of the migrating IAB-node and/or the downstream devices of the migrating IAB-node during the inter-donor migration of the migrating IAB-node, addressing at least some of the problems discussed above. In the embodiments, the downstream IAB-node and/or corresponding UEs may send PDCP status report to the target IAB-node without receiving either PDCP data recovery or PDCP re-establishment process.

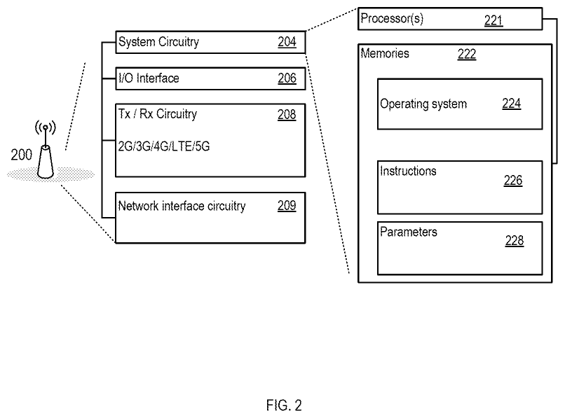

FIG. 2 shows an exemplary wireless communication base station 200. The wireless communication base station 200 may be an exemplary implementation of at least one of the IAB-donors (130 and 135) and the IAB-nodes (152, 154, 156, and 158) in FIG. 1. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

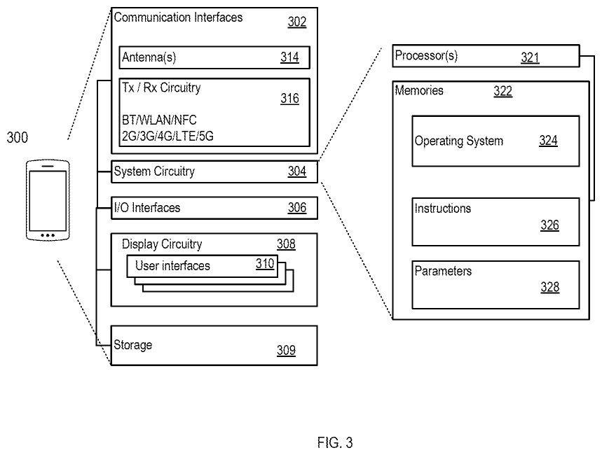

FIG. 3 shows an exemplary user equipment (UE) 300. The UE 300 may be a mobile device, for example, a smart phone or a mobile communication module disposed in a vehicle. The UE 300 may be an exemplary implementation of at least one of the UEs (172, 174, and 176) in FIG. 1. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input / output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation / demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE) , and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for updating data transmission for at least one downstream device of a migrating integrated access backhaul node (IAB-node) during inter-donor migration, which may be implemented, partly or totally, on the wireless network base station and/or the user equipment described above in FIGS. 2 and 3.

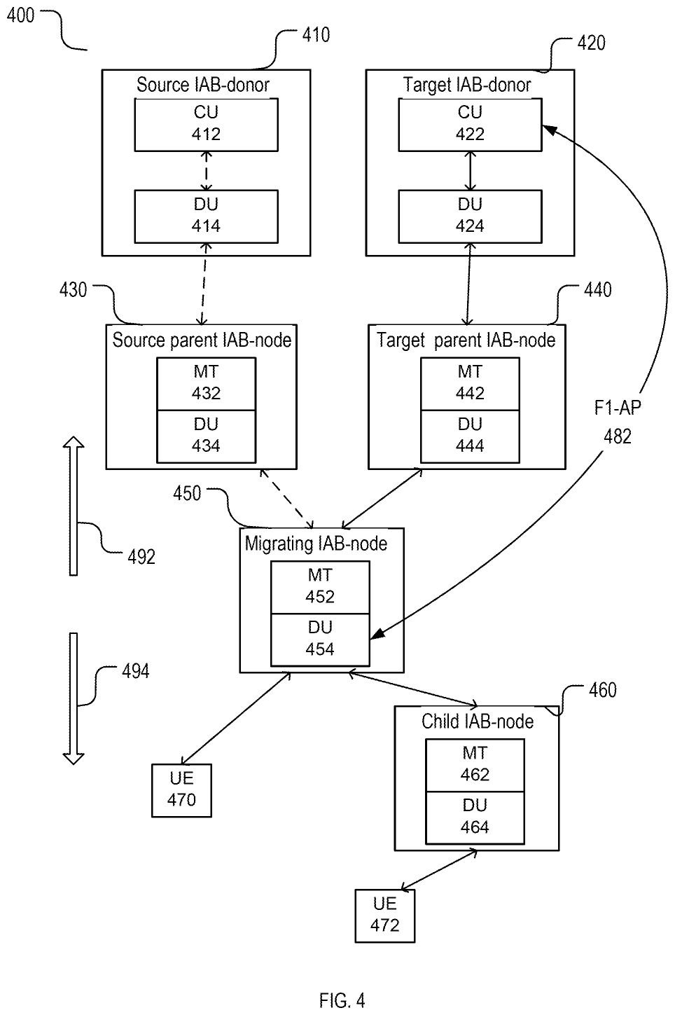

Referring to FIG. 4, an IAB system 400 may include one or more IAB-donors (410 and 420). An IAB-node 450, which currently connects to the IAB-donor 410 via an IAB-node 430, may migrate to the IAB-donor 420 via an IAB-node 440. This may be called an inter-donor migration. The IAB-node 450 may be a migrating IAB-node; the IAB-donor 410 may be a source IAB-donor; the IAB-node 430 may be a source parent IAB-node; the IAB-donor 420 may be a target IAB-donor; the IAB-node 440 may be a target parent IAB-node.

In some embodiments, for one IAB-node, there may be one or more upstream IAB-nodes 492, which may collectively connect the IAB-node to the corresponding IAB-donor; and there may be one or more downstream devices 494 connecting to the IAB-node, which may include one or more downstream IAB-nodes and/or one or more downstream UEs.

In some embodiments, the migrating IAB-node 450 may connect to a IAB-donor via one or more IAB-nodes, which may be collectively called as parent IAB-nodes.

The source IAB-donor 410 may include a central unit (CU) 412 and a distributed unit (DU) 414, and the source IAB-donor CU 412 may communicate with the source IAB-donor DU 414. The source parent IAB-node 430 in communication with the source IAB-donor 410 may include a mobile termination (MT) 432 and a distributed unit (DU) 434. The target IAB-donor 420 may include a CU 422 and a DU 424, and the target IAB-donor CU 422 may communicate with the target IAB-donor DU 424. The target IAB-node 440 in communication with the target IAB-donor 420 may include a MT 442 and a DU 444.

Prior to inter-donor migration, the migrating IAB-node 450 may be in communication with the source parent IAB-node 430. The migrating IAB-node 450 may include a MT 452 and a DU 454. In one implementation, the migrating IAB-node 450 may be in communication with a UE 470. In another implementation, the migrating IAB-node 450 may be in communication with a child IAB-node 460. The child IAB-node 460 may include a MT 462 and a DU 464. In one implementation, the child IAB-node 460 may be in communication with a UE 472.

Referring to FIG. 4, the migrating IAB-node 450 may change its attachment point from the source parent IAB-node 430 connecting to the source IAB-donor 410 to a target IAB-node 440 connecting to the target IAB-donor 420. In one implementation, a handover (HO) process may occur during the inter-donor migration, and this may be an inter-CU HO scenario. The migrating IAB-node DU 454 may communicate with the target IAB-donor CU 422 via F1-AP message 482.

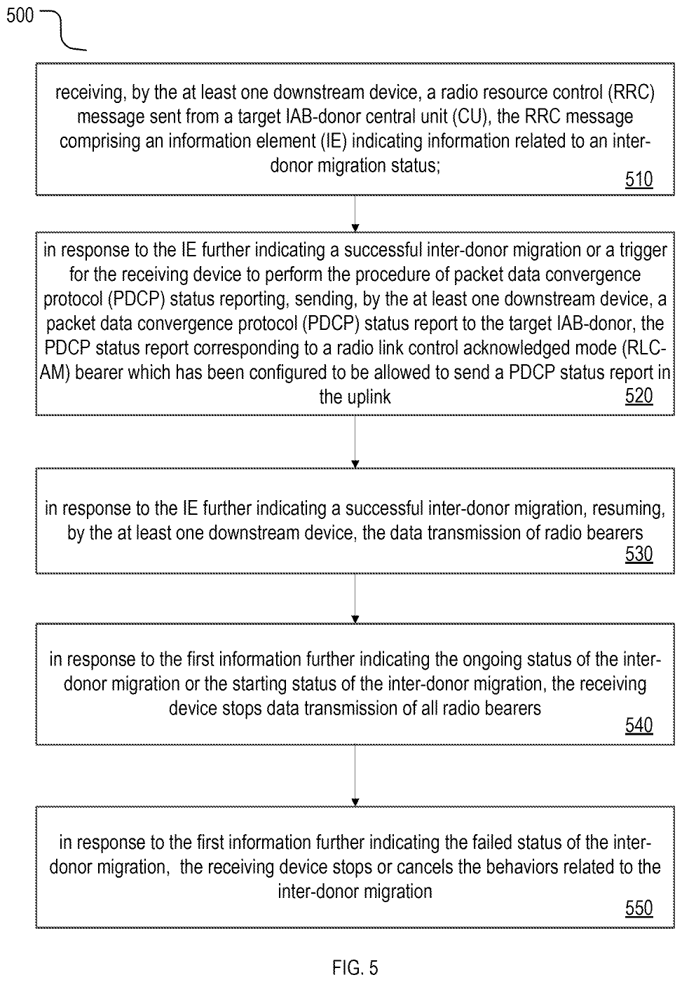

Referring to FIG. 5, the present disclosure describes various embodiment of a method 500 for using a radio resource control (RRC) message to inform at least one downstream device of a migrating integrated access backhaul node (IAB-node) that the migrating IAB-node occurs an inter-donor migration from a source IAB-donor to a target IAB-donor. The method may solve a problem/issue associated with requiring PDCP data recovery and/or PDCP re-establishment for a receiving device to trigger sending PDCP status reporting.

The method 500 may include a portion or all of the following steps: step 510: receiving, by the at least one downstream device of the migrating IAB-node, a radio resource control (RRC) message sent from a target IAB-donor central unit (CU), the RRC message comprising an information element (IE) indicating that the migrating IAB-node occurs an inter-donor migration; and step 520: in response to the IE further indicating a successful inter-donor migration or a trigger for the receiving device to perform the procedure of packet data convergence protocol (PDCP) status reporting, sending, by the at least one downstream device, a packet data convergence protocol (PDCP) status report to the target IAB-donor, the PDCP status report corresponding to a radio link control acknowledged mode (RLC-AM) bearer which has been configured to be allowed to send a PDCP status report in the uplink.

The method 500 may optionally and additionally or alternatively include step 530: in response to the IE further indicating a successful inter-donor migration, resuming, by the at least one downstream device, the data transmission of radio bearers.

The method 500 may optionally and additionally or alternatively include step 540: in response to the first information further indicating the ongoing status of the inter-donor migration or the starting status of the inter-donor migration, the receiving device stops data transmission of all radio bearers.

The method 500 may optionally and additionally or alternatively include step 550: in response to the first information further indicating the failed status of the inter-donor migration, the receiving device stops or cancels the behaviors related to the inter-donor migration.

In one implementation, the RRC message may be a RRC Reconfiguration message.

In one implementation, the IE may indicate a status of the inter-donor migration. In one implementation, the IE may include a value of either TRUE or FALSE. In another implementation, the IE may include a value of TRUE only.

In one implementation, the TRUE value of the IE in the RRC message may indicate a successful inter-donor migration. In another implementation, the TRUE value of the IE may indicate to trigger the at least one downstream device to send the PDCP status report corresponding to a radio link control acknowledged mode (RLC-AM) bearer which has been configured to be allowed to send the PDCP status report in the uplink.

In one implementation, the FALSE value of the IE in the RRC message may indicate a failed inter-donor migration. In another implementation, the FALSE value of the IE may indicate not to trigger the receiving end to send the PDCP status report corresponding to the RLC-AM bearer which has been configured to be allowed to send the PDCP status report in the uplink.

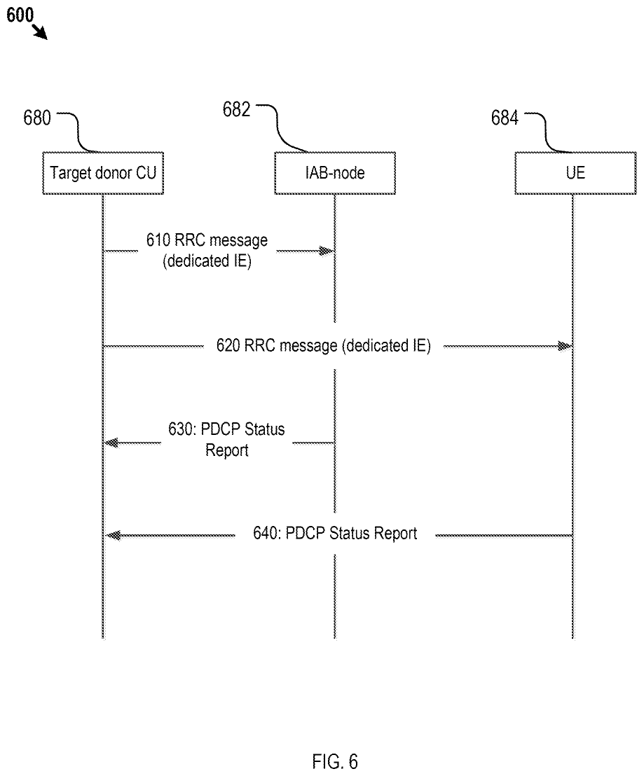

FIG. 6 shows a logic flow of a method 600 for using a RRC message to update data transmission for at least one downstream device of a migrating IAB-node during an inter-donor migration from a source IAB-donor to a target IAB-donor. In another implementation, FIG. 6 shows a logic flow of a method 600 for using a RRC message to inform at least one downstream device of a migrating IAB-node that the migrating IAB-node occurs an inter-donor migration from a source IAB-donor to a target IAB-donor.

Referring to step 610 in FIG. 6, after inter-donor migration, a target IAB-donor CU 680 may send a RRC message to an IAB-node MT 682. In one implementation, the IAB-node may include a migrating IAB-node. In another implementation, the IAB-node may include a downstream IAB-node of the migrating IAB-node.

Referring to step 620 in FIG. 6, during an inter-donor migration, the target IAB-donor CU 680 may send a RRC message to a UE 684. In one implementation, the UE 684 may include a UE connecting with the migrating IAB-node. In another implementation, the UE 684 may include a UE connecting to a downstream IAB-node of the migrating IAB-node.

Referring to step 630 in FIG. 6, in response to the received RRC message including the IE indicating a successful inter-donor migration, the IAB-node MT 682 may sends a packet data convergence protocol (PDCP) status report to the target IAB-donor. The PDCP status report may correspond to a radio link control acknowledged mode (RLC-AM) bearer which has been configured to be allowed to send a PDCP status report in a uplink.

Referring to step 640 in FIG. 6, in response to the received RRC message including the IE indicating a successful inter-donor migration, the UE 684 may sends a PDCP status report to the target IAB-donor. The PDCP status report may correspond to a radio link control acknowledged mode (RLC-AM) bearer which has been configured to be allowed to send a PDCP status report in a uplink.

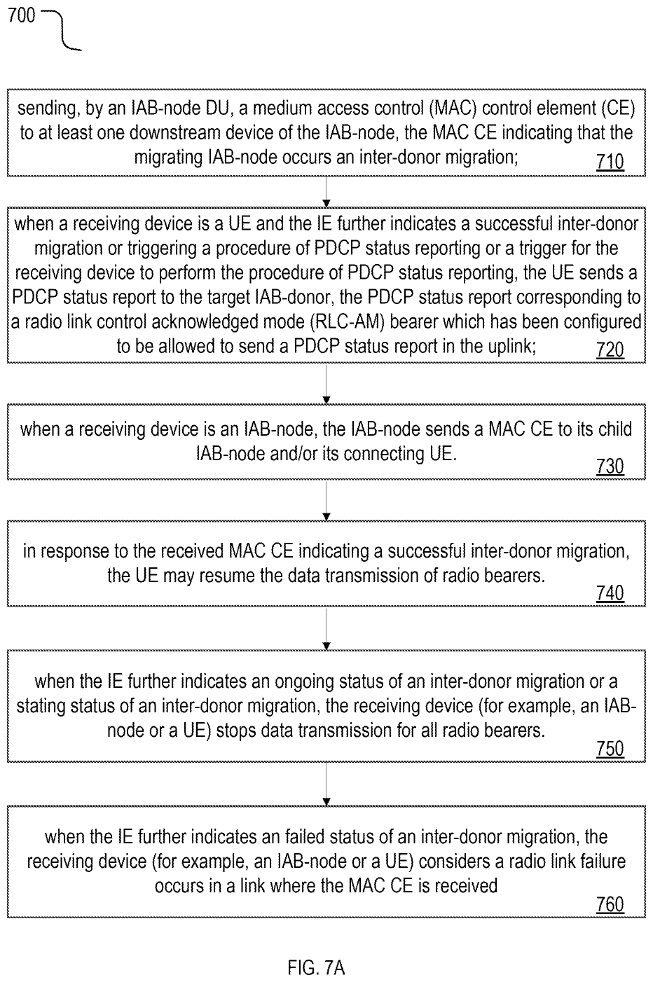

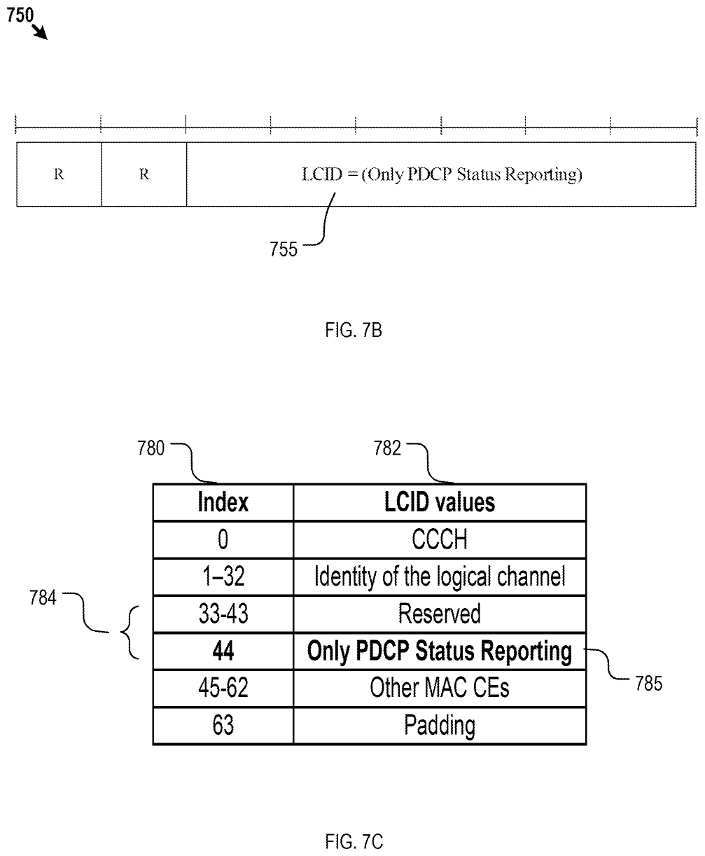

Referring to FIG. 7A, the present disclosure describes various embodiment of a method 700 for using a medium access control (MAC) control element (CE) to inform at least one downstream device of a migrating integrated access backhaul node (IAB-node) that the migrating IAB node occurs an inter-donor migration from a source IAB-donor to a target IAB-donor. The method may solve a problem/issue associated with requiring PDCP data recovery and/or PDCP re-establishment for a receiving device to trigger sending PDCP status reporting.

The method 700 may include a portion or all of the following steps: step 710: sending, by an IAB-node DU, a medium access control (MAC) control element (CE) to at least one downstream device of the IAB-node, the MAC CE indicating that the migrating IAB-node occurs an inter-donor migration; step 720: when a receiving device is a UE and the IE further indicates a successful inter-donor migration or triggering a procedure of PDCP status reporting or a trigger for the receiving device to perform the procedure of PDCP status reporting, the UE sends a PDCP status report to the target IAB-donor, the PDCP status report corresponding to a radio link control acknowledged mode (RLC-AM) bearer which has been configured to be allowed to send a PDCP status report in the uplink; step 730: when a receiving device is an IAB-node, the IAB-node sends a MAC CE to its child IAB-node and/or its connecting UE; step 740: in response to the received MAC CE indicating a successful inter-donor migration, the UE may resume the data transmission of radio bearers; step 750: when the IE further indicates an ongoing status of an inter-donor migration or a stating status of an inter-donor migration, the receiving device (for example, an IAB-node or a UE) stops data transmission for all radio bearers; and step 760: when the IE further indicates an failed status of an inter-donor migration, the receiving device (for example, an IAB-node or a UE) considers a radio link failure occurs in a link where the MAC CE is received.

In one implementation referring to FIG. 7B, the MAC CE is identified by a MAC subheader 750 including a logic channel ID (LCID) 755. In another implementation, the LCID may include a reserved value which has no conflict with other values. For example referring to FIG. 7C, a LCID value 782 may correspond to an index 780 to the LCID value. For the LCID shown in FIG. 7B, the LCID may have 6 binary bits, and the value of LCID for downlink-shared channel (DL-SCH) may include a reserved range 784 of between 33 and 44, inclusive; and the Only PDCP Status Reporting 785 may include a value of 44. In another implementation, the MAC CE may have a fixed size of zero bits for its load.

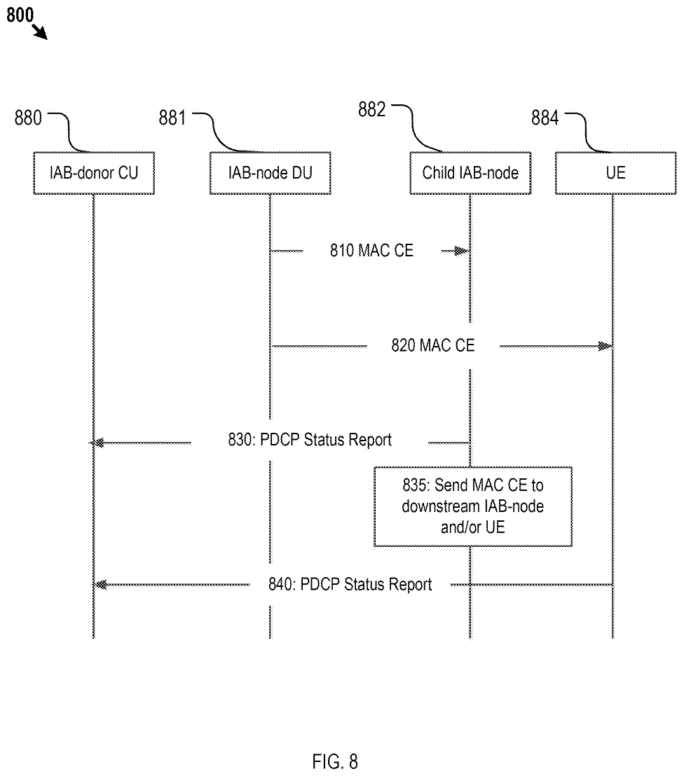

FIG. 8 shows a logic flow of a method 800 for using a MAC CE to update data transmission for at least one downstream device of a migrating IAB-node during an inter-donor migration from a source IAB-donor to a target IAB-donor. In another implementation, FIG. 8 shows a logic flow of a method 600 for using a MAC CE to inform at least one downstream device of a migrating IAB-node that the migrating IAB-node occurs an inter-donor migration from a source IAB-donor to a target IAB-donor.

Referring to step 810 in FIG. 8, during am inter-donor migration, when one of the following conditions is satisfied, an IAB-node DU 881 may send a MAC CE to a child IAB-node MT 682.

In one implementation, the IAB-node may include a migrating IAB-node; and the condition may include that the migrating IAB-node succeeds in establishing or fails in establishing or undergoes establishing a connection with an upstream device. The upstream device may include one of the target IAB-donor and a target parent IAB-node of the migrating IAB-node.

In another implementation, the IAB-node may include a target parent IAB-node of the migrating IAB-node; and condition may include that the migrating IAB-node succeeds in establishing or fails in establishing or undergoes establishing or starts establishing a connection with the target parent IAB-node of the migrating IAB-node.

In another implementation, the IAB node may include a child IAB-node; and the condition may include whether the child IAB-node receives the MAC CE from a parent IAB-node of the child IAB-node.

In another implementation, the condition may include the migrating IAB-node; and the preset condition may include that the migrating IAB-node receives a radio resource control (RRC) message sent from a target IAB-donor CU and the received RRC message comprises an information element (IE) indicating an information related to inter-donor migration.

Referring to step 820 in FIG. 8, during an inter-donor migration, when the condition is satisfied, the IAB-node DU 881 may send a MAC CE to a UE 884. The UE 884 connects to the IAB-node.

Referring to step 830 in FIG. 8, optionally and additionally, in response to the received MAC CE indicating a successful inter-donor migration or a trigger for the receiving device to perform procedure of packet data convergence protocol (PDCP) status reporting, the IAB-node 882 may send a PDCP status report to the target IAB-donor 880. The PDCP status report may correspond to a radio link control acknowledged mode (RLC-AM) bearer which has been configured to be allowed to send a PDCP status report in a uplink.

Referring to step 835 in FIG. 8, in response to the received MAC CE, the IAB-node 882 may send the MAC CE to one or more downstream IAB-node and/or UE of the IAB-node 882.

Referring to step 840 in FIG. 8, in response to the received MAC CE indicating a successful inter-donor migration or a trigger for the receiving device to perform procedure of packet data convergence protocol (PDCP) status reporting, the UE 884 may send a PDCP status report to the target IAB-donor 880. The PDCP status report may correspond to a RLC-AM bearer, which has been configured to be allowed to send a PDCP status report in an uplink.

Referring to step 840 in FIG. 8, in response to the received MAC CE indicating a successful inter-donor migration, the UE 884 may resume the data transmission of radio bearers.

Referring to step 835 and step 840 in FIG. 8, in response to the received MAC CE indicating an ongoing status of inter-donor migration or a starting status of inter-donor migration, the receiving device (the IAB-node 882, or the UE 884) may stop data transmission of all radio bearers.

Referring to step 835 and step 840 in FIG. 8, in response to the received MAC CE indicating failed status of inter-donor migration, the receiving device (the IAB-node 882, or the UE 884) may consider a radio link failure occurs in a link where the MAC CE is received.

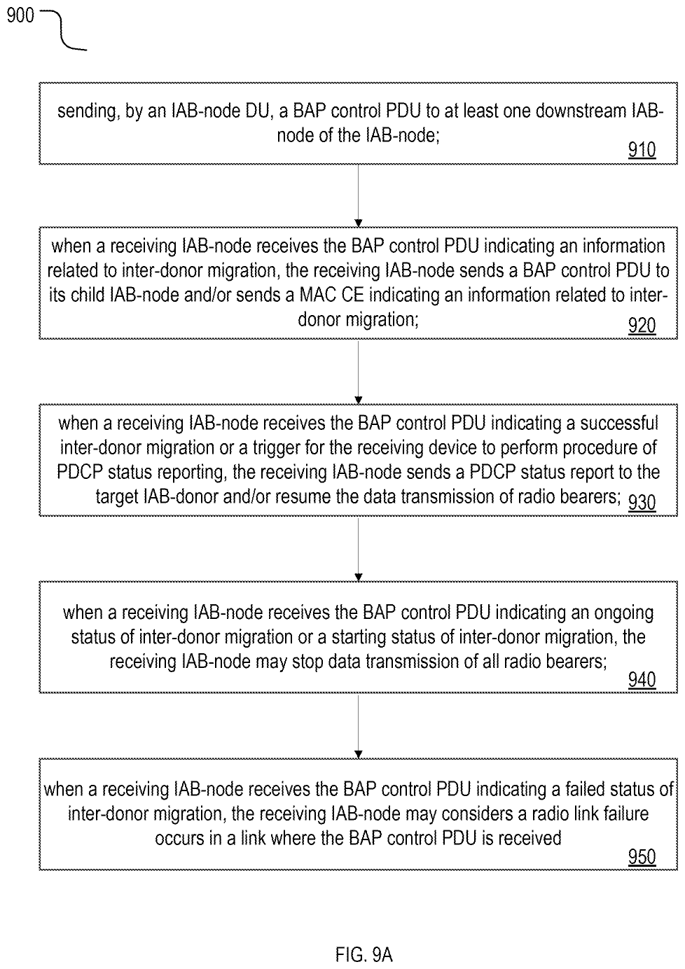

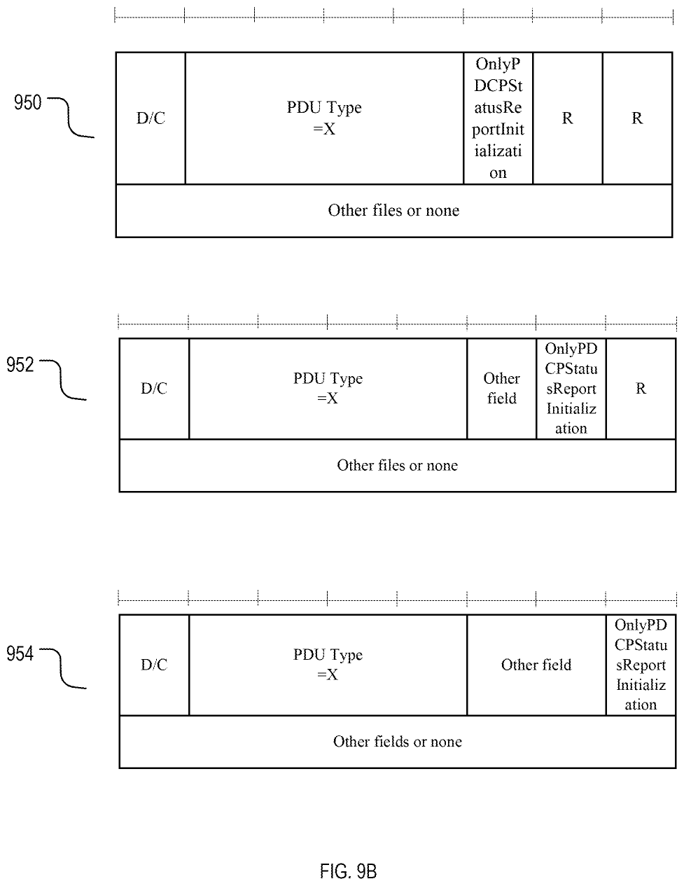

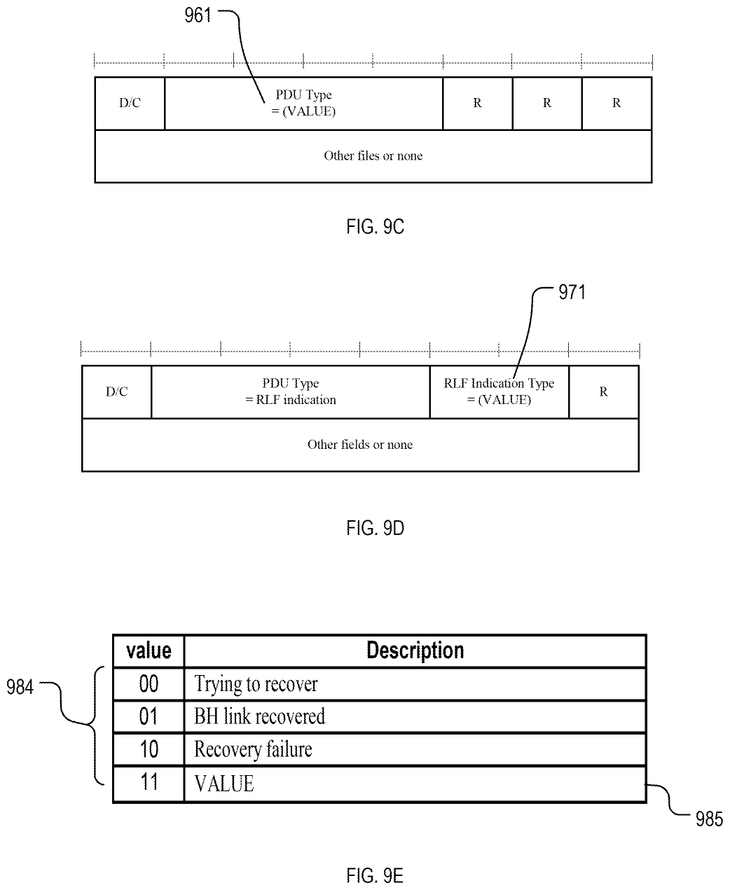

Referring to FIG. 9A, the present disclosure describes various embodiment of a method 900 for using a backhaul adaptation protocol (BAP) control protocol data unit (PDU) to inform at least one downstream device of a migrating integrated access backhaul node (IAB-node) of an information related to inter-donor migration where the migrating IAB-node migrates from a source IAB-donor to a target IAB-donor. The method may solve a problem/issue associated with requiring PDCP data recovery and/or PDCP re-establishment for a receiving device to trigger sending PDCP status reporting. The information related to inter-donor migration in BAP control PDU further comprising that at least one of an upstream IAB nodes of the first IAB-node occurs an inter-donor migration from a source IAB-donor to a target IAB-donor, or a successful status of the inter-donor migration, or an ongoing status of the inter-donor migration, or a starting status of the inter-donor migration, or a failed status of the inter-donor migration, or an indication triggering the receiving device to perform the procedure of packet data convergence protocol (PDCP) status reporting

The method 900 may include a portion or all of the following steps: step 910: sending, by an IAB-node DU, a BAP control PDU to at least one downstream IAB-node of the IAB-node; step 920: when a receiving IAB-node receives the BAP control PDU indicating an information related to inter-donor migration, the receiving IAB-node sends a BAP control PDU to its child IAB-node and/or sends a MAC CE indicating an information related to inter-donor migration; and step 930: when a receiving IAB-node receives the BAP control PDU indicating a successful inter-donor migration or a trigger for the receiving device to perform procedure of PDCP status reporting, the receiving IAB-node sends a PDCP status report to the target IAB-donor and/or resume the data transmission of radio bearers; and step 940: when a receiving IAB-node receives the BAP control PDU indicating an ongoing status of inter-donor migration or a starting status of inter-donor migration, the receiving IAB-node may stop data transmission of all radio bearers; and step 950: when a receiving IAB-node receives the BAP control PDU indicating a failed status of inter-donor migration, the receiving IAB-node may considers a radio link failure occurs in a link where the BAP control PDU is received.

In some embodiments referring to FIG. 9B, the BAP control PDU may include a dedicated information element (IE) in any one of the three configuration formats 950, 952, and 954. In one implementation, the IE may be called as OnlyPDCPStatusReportInitialization.

In one implementation, the IE may indicate a status of the inter-donor migration. In one implementation, the IE may include a value of either TRUE or FALSE. In another implementation, the IE may include a value of TRUE only.

In one implementation, the TRUE value of the IE in the BAP control PDU may indicate a successful inter-donor migration. In another implementation, the TRUE value of the IE may indicate to trigger the at least one downstream device to send the PDCP status report corresponding to a radio link control acknowledged mode (RLC-AM) bearer which has been configured to be allowed to send the PDCP status report in the uplink.

In one implementation, the FALSE value of the IE in the BAP control PDU may indicate a failed inter-donor migration. In another implementation, the FALSE value of the IE may indicate a radio link failure occurs in a link where the BAP control PDU is received.

In some embodiments referring to FIGS. 9C and 9D, the BAP control PDU may include assigning a dedicated value to one already existing information element. The dedicated value may include a reserved value which has no conflict with other values.

In one implementation referring to FIG. 9C, a PDU type 961 may be used, and a new dedicated value may be assigned to the PDU type. In one implementation, the dedicated value for the PDU type in the BAP control PDU may indicate a trigger for downstream nodes to perform PDCP status reporting, or a status of the inter-donor migration selected form any subset of a set including a successful status, a failed status, an ongoing status, and a starting status. In another implementation, the dedicated value for the PDU type in the BAP control PDU may indicate to trigger the at least one downstream device to send the PDCP status report corresponding to a radio link control acknowledged mode (RLC-AM) bearer which has been configured to be allowed to send the PDCP status report in the uplink.

In another implementation referring to FIG. 9D, a radio link failure (RLF) indication type 971 may be used, and a new dedicated value may be assigned to the RLF indication type. For example in FIGS. 9D and 9E, the RLF indication type may have 2 binary bits, and the binary value of RLF indication type may include a reserved range 984 of between 00 and 11, inclusive; and as an example but not limited to, the dedicated value 985 indicating a status of inter-donor migration or a trigger for downstream nodes to perform may include a binary value of 11.

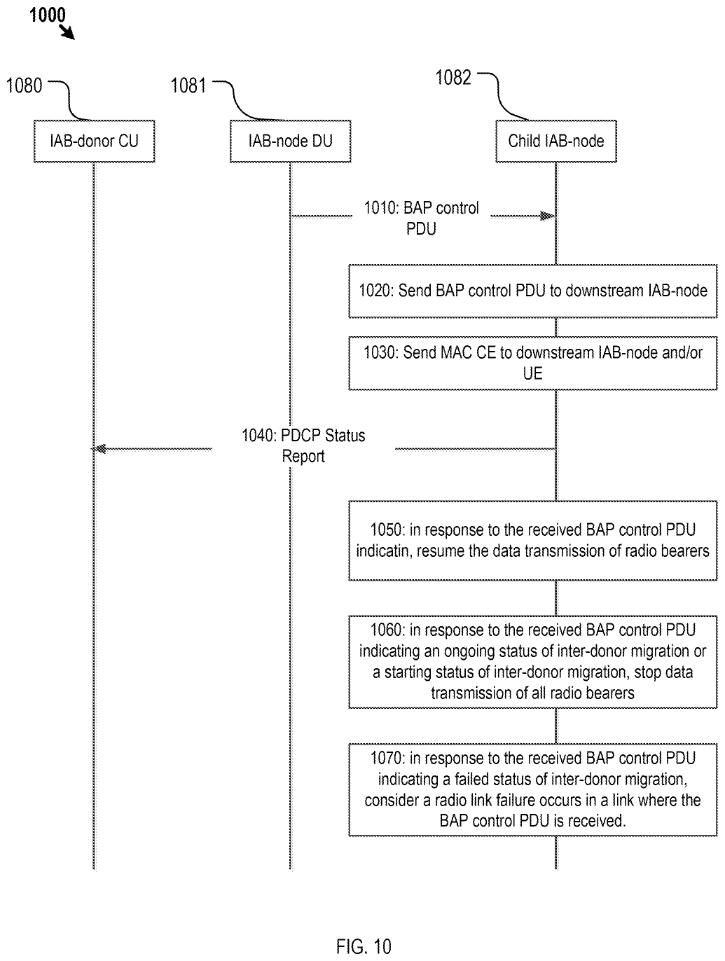

FIG. 10 shows a logic flow of a method 1000 for using a BAP control PDU to update data transmission for at least one downstream device of a migrating IAB-node during an inter-donor migration from a source IAB-donor to a target IAB-donor. In another implementation, FIG. 10 shows a logic flow of a method 1000 for using a BAP control PDU to inform at least one downstream device of a migrating IAB-node that the migrating IAB-node occurs an inter-donor migration from a source IAB-donor to a target IAB-donor.

Referring to step 1010 in FIG. 10, during an inter-donor migration, when the following condition is satisfied, an IAB-node DU 1081 may send a BAP control PDU to a child IAB-node MT 1082.

In one implementation, the IAB-node may include a migrating IAB-node; and the condition may include whether the migrating IAB-node successfully establishes a connection with an upstream device. The upstream device may include one of the target IAB-donor and a target parent IAB-node of the migrating IAB-node.

In another implementation, the IAB-node may include a target parent IAB-node of the migrating IAB-node; and the condition may include whether the migrating IAB-node successfully establishes a connection with the target parent IAB-node of the migrating IAB-node.

In another implementation, the IAB node may include a child IAB-node; and the condition may include whether the child IAB-node receives the BAP control PDU from a parent IAB-node of the child IAB-node.

In another implementation, optionally and alternatively, the IAB node 1081 in FIG. 10 may include the migrating IAB-node; and the preset condition may include that the migrating IAB-node receives a radio resource control (RRC) message sent from a target IAB-donor CU and the received RRC message comprises an information element (IE) indicating an information related to inter-donor migration.

Referring to step 1020 in FIG. 10, in response to the received BAP control PDU, the child IAB-node 1082 may send a BAP control PDU to one or more downstream IAB-nodes of the child IAB-node 1082.

Optionally and additionally or alternatively, referring to step 1030 in FIG. 10, in response to the received BAP control PDU, the child IAB-node 1082 may send a MAC CE to one or more downstream IAB-node and/or UE of the child IAB-node 1082. The MAC CE may be any embodiments as discussed above.

Optionally and additionally or alternatively, referring to step 1040 in FIG. 10, in response to the received BAP control PDU indicating a successful status of inter-donor migration or a trigger for downstream nodes to perform PDCP status reporting, the IAB-node 1082 may send a PDCP status report to the target IAB-donor 1080. The PDCP status report may correspond to a radio link control acknowledged mode (RLC-AM) bearer that has been configured to be allowed to send a PDCP status report in an uplink.

Optionally and additionally or alternatively, referring to step 1050 in FIG. 10, in response to the received BAP control PDU indicating the child IAB-node 1082 may resume the data transmission of radio bearers.

Optionally and additionally or alternatively, referring to step 1060 in FIG. 10, in response to the received BAP control PDU indicating an ongoing status of inter-donor migration or a starting status of inter-donor migration, the child IAB-node 1082 may stop data transmission of all radio bearers.

Optionally and additionally or alternatively, referring to step 1070 in FIG. 10, in response to the received BAP control PDU indicating a failed status of inter-donor migration, the child IAB-node 1082 may consider a radio link failure occurs in a link where the BAP control PDU is received.

The present disclosure describes methods, apparatus, and computer-readable medium for wireless communication. The present disclosure addressed the issues with updating data transmission of one or more downstream integrated access backhaul (IAB) nodes during inter-donor migration. The methods, devices, and computer-readable medium described in the present disclosure may facilitate the performance of wireless communication by using a RRC message, or using a MAC CE, or using a BAP control PDU to inform at least one downstream device of a migrating IAB-node during inter-donor migration, thus improving migration efficiency and overall wireless network performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a receiving device, a radio resource control (RRC) message sent from a transmitting device, the RRC message comprising first information which indicates inter IAB-donor migration related information, the transmitting device comprising one of a subset, the subset comprising at least one of a target nodeB (gNB), a target gNB central unit (gNB-CU), a source gNB, and a source gNB-CU.

2. The method according to claim 1, wherein:
the first information further indicates one of a subset, the subset comprising at least one of that at least one upstream integrated access backhaul node (IAB-node) of the receiving device occurs an inter-donor migration from a source IAB-donor to a target IAB-donor, a successful status of the inter-donor migration, an ongoing status of the inter-donor migration, a failed status of the inter-donor migration, a starting status of the inter-donor migration, and an indication of triggering the receiving device to perform a procedure of packet data convergence protocol (PDCP) status reporting.

3. The method according to claim 2, wherein:
in response to the first information indicating a successful status of the inter-donor migration, the receiving device triggers to send one or more packet data convergence protocol (PDCP) status reports to the target IAB-donor, a PDCP status report corresponding to a radio link control acknowledged mode (RLC-AM) bearer which has been configured to be required to send the PDCP status report in an uplink.

4. The method according to claim 2, wherein:
in response to the first information indicating triggering the receiving device to perform the procedure of packet data convergence protocol (PDCP) status reporting, the receiving device triggers to send one or more packet data convergence protocol (PDCP) status reports to the target IAB-donor, a PDCP status report corresponding to a radio link control acknowledged mode (RLC-AM) bearer which has been configured to be required to send the PDCP status report in an uplink.

5. The method according to claim 2, wherein:
in response to the first information indicating the ongoing status of the inter-donor migration or the starting status of the inter-donor migration, the receiving device stops data transmission of all radio bearers.

6. The method according to claim 2, wherein:
in response to the first information indicating the failed status of the inter-donor migration, the receiving device stops or cancels behaviors related to the inter-donor migration.

7. The method according to claim 1, wherein:
the receiving device comprises at least one user equipment (UE) connecting to a migrating IAB-node.

8. The method according to claim 1, wherein:
the receiving device comprises at least one user equipment (UE) connecting to a downstream IAB-node of a migrating IAB-node.

9. The method according to claim 1, wherein:
the receiving device comprises at least one downstream IAB-node of a migrating IAB-node.

10-32. (canceled)

33. An apparatus comprising:
a memory storing instructions; and
a processor in communication with the memory, wherein, when the processor executes the instructions, the processor is configured to cause the apparatus to perform:
receiving a radio resource control (RRC) message sent from a transmitting device, the RRC message comprising first information which indicates inter IAB-donor migration related information, the transmitting device comprising one of a subset, the subset comprising at least one of a target nodeB (gNB), a target gNB central unit (gNB-CU), a source gNB, and a source gNB-CU.

34. The apparatus according to claim 33, wherein:
the first information further indicates one of a subset, the subset comprising at least one of that at least one upstream integrated access backhaul node (IAB-node) of the apparatus occurs an inter-donor migration from a source IAB-donor to a target IAB-donor, a successful status of the inter-donor migration, an ongoing status of the inter-donor migration, a failed status of the inter-donor migration, a starting status of the inter-donor migration, and an indication of triggering the apparatus to perform a procedure of packet data convergence protocol (PDCP) status reporting.

35. The apparatus according to claim 34, wherein:
in response to the first information indicating a successful status of the inter-donor migration, the apparatus triggers to send one or more packet data convergence protocol (PDCP) status reports to the target IAB-donor, a PDCP status report corresponding to a radio link control acknowledged mode (RLC-AM) bearer which has been configured to be required to send the PDCP status report in an uplink.

36. The apparatus according to claim 34, wherein:
in response to the first information indicating triggering the apparatus to perform the procedure of packet data convergence protocol (PDCP) status reporting, the apparatus triggers to send one or more packet data convergence protocol (PDCP) status reports to the target IAB-donor, a PDCP status report corresponding to a radio link control acknowledged mode (RLC-AM) bearer which has been configured to be required to send the PDCP status report in an uplink.

37. The apparatus according to claim 34, wherein:
in response to the first information indicating the ongoing status of the inter-donor migration or the starting status of the inter-donor migration, the apparatus stops data transmission of all radio bearers.

38. The apparatus according to claim 34, wherein:
in response to the first information indicating the failed status of the inter-donor migration, the apparatus stops or cancels behaviors related to the inter-donor migration.

39. The apparatus according to claim 33, wherein:
the apparatus comprises at least one user equipment (UE) connecting to a migrating IAB-node.

40. The apparatus according to claim 33, wherein:
the apparatus comprises at least one user equipment (UE) connecting to a downstream IAB-node of a migrating IAB-node.

41. The apparatus according to claim 33, wherein:
the apparatus comprises at least one downstream IAB-node of a migrating IAB-node.

42. A computer program product comprising a computer-readable program medium storing instructions, wherein, the instructions, when executed by a processor, are configured to cause the processor to perform:
receiving a radio resource control (RRC) message sent from a transmitting device, the RRC message comprising first information which indicates inter IAB-donor migration related information, the transmitting device comprising one of a subset, the subset comprising at least one of a target nodeB (gNB), a target gNB central unit (gNB-CU), a source gNB, and a source gNB-CU.

43. The computer program product according to claim 42, wherein:
the first information further indicates one of a subset, the subset comprising at least one of that at least one upstream integrated access backhaul node (IAB-node) of an apparatus comprising the processor occurs an inter-donor migration from a source IAB-donor to a target IAB-donor, a successful status of the inter-donor migration, an ongoing status of the inter-donor migration, a failed status of the inter-donor migration, a starting status of the inter-donor migration, and an indication of triggering the apparatus to perform a procedure of packet data convergence protocol (PDCP) status reporting.
